(19) United States
(12) Patent Application Publication
(10) Pub. No.: US 2015/0186848 A1
(43) Pub. Date: Jul. 2, 2015

(54) Third Party Interview Method

(71) Applicant: Danny Wu, La Palma, CA (US)

(72) Inventor: Danny Wu, La Palma, CA (US)

(21) Appl. No.: 14/588,110

(22) Filed: Dec. 31, 2014

Related U.S. Application Data
(60) Provisional application No. 61/922,783, filed on Dec. 31, 2013.

(51) Int. Cl. G06Q 10/10

(52) U.S. Cl. CPC G06Q 10/1053

(57) ABSTRACT

For third party interviews, a method selects a case type interview in response to a skill requirement. In addition, the method selects an interviewer in response to the skill requirement. The method further displays the case type interview to the interviewer and displays model answers corresponding to the case type interview. The method further receives an evaluation based on the model answers.

### CROSS-REFERENCE TO RELATED APPLICATIONS

This application claims priority to U.S. Provisional Patent Application No. 61/922,783 entitled “Blind and Cloud Third Party Interview Service Model. The model is to provide impartial technical interview as a trusted service to Information Technology hiring parties via a networked computer platform” and filed on Dec. 31, 2013 for Danny Wu, which is incorporated herein by reference.

### BACKGROUND

1. Field

The subject matter disclosed herein relates to interviews and more particularly relates to a third party interview method.

2. Description of the Related Art

Job applicants are typically interviewed prior to hiring.

### BRIEF SUMMARY

A method for third party interviews is disclosed. The method selects a case type interview in response to a skill requirement. In addition, the method selects an interviewer in response to the skill requirement. The method further displays the case type interview to the interviewer and displays model answers corresponding to the case type interview. The method further receives an evaluation based on the model answers. An apparatus and computer program product also perform the functions of the method.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of an interview process;

FIG. 1B is a schematic block diagram illustrating one embodiment of an interview system;

FIG. 2A is a schematic block diagram illustrating one embodiment of a case database;

FIG. 2B is a schematic block diagram illustrating one embodiment of a case;

FIG. 2C is a schematic block diagram illustrating one embodiment of a case type interview;

FIG. 2D is a schematic block diagram illustrating one embodiment of interview data;

FIG. 3A is a schematic block diagram illustrating one embodiment of a skill data;

FIG. 3B is a schematic block diagram illustrating one embodiment of a interviewer data;

FIG. 4 is a schematic block diagram illustrating one embodiment of a computer;

FIGS. 5A-B are schematic flow chart diagrams illustrating one embodiment of a third party interview method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

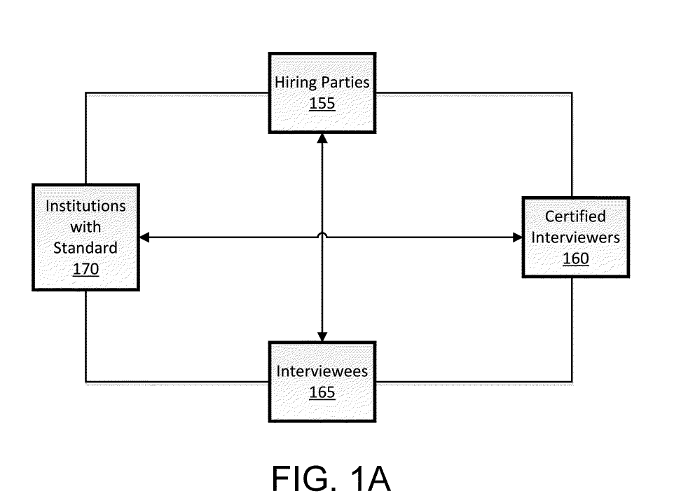

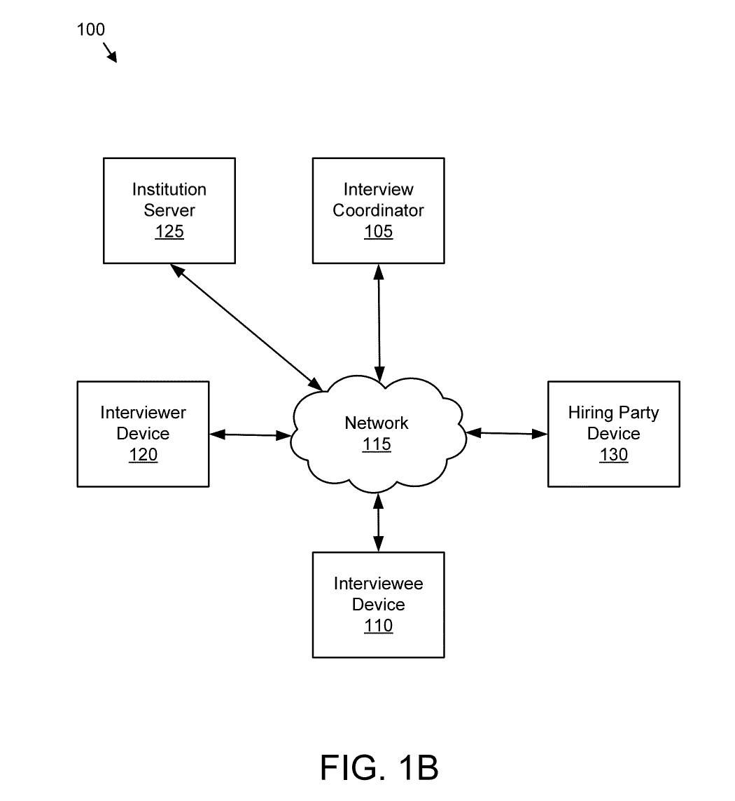

FIG. 1A is a schematic block diagram illustrating one embodiment of an interview process 150. Hiring parties 155 consider interviewees 165 as candidates for skills. The hiring parties 155 desire to know whether the interviewees 165 have needed skills in order to work with products produced by institutions with a standard 170. The institutions with the standard 170 may be software vendors, hardware vendors, or the like. The standards may be skills related to the products and working knowledge on the products.

Today's economy demands large amount of qualified technical professionals on worldwide basis. This is especially true for IT industry. Hiring parties 155 strive to hire the right people, lower turnover, mitigate risks, and eventually contribute to the organization's bottom line. As for the tele-interview process, besides saving on hiring cost, hiring parties 155 nevertheless call for standardized process leading to unbiased, impartial evaluation. In addition to making hiring decision, determining skill level and compensation also needs a benchmark. Only a credible third party is best positioned to handle the remote technical interviewing process.

Telephonic technical interview without video feed is widely practiced in the IT industry, especially for IT outsourcing companies that eventually the hired people are either dispatched to hiring party sites or work remotely. Inevitably this cost effective practice invites various formats of fraudulent activities. Although it sounds rather common sense to “know” the candidates before the interview, this may actually create bias in different ways upfront. A bad hire decision can cost not only direct productivity loss but also ruin hiring party relationship. Therefore there is incentive for hiring managers to mitigate such risks and even better to obtain assurance and insurance.

Similar to IT outsourcing services, IT personnel, especially for packaged software, the required skill sets are essentially the same compared to diversity in personal character. Even different employers and hiring parties use proprietary and very likely biased technical interview methods, they are actually looking for the same people quality. This nature of homogeneity opens up an opportunity to form an industry standard and to streamline the process that is best accomplished by a credible external and independent service provider such as an institution with standards 170 or a interviewer coordinator.

In general most technical people are not properly trained on playing interviewer role and most HR and hiring managers are not from related technology background. This third party remote interview model is ideal for technical interview or general initial screening, it does not evaluate other soft skills or “chemistry”, the employers and hiring parties still bear the primary responsibility to make the hiring decision.

FIG. 1B is a schematic block diagram illustrating one embodiment of an interview system 100. The system 100 provides third-party interviews for candidates such as technical professionals. The system 100 includes an interview coordinator 105, a network 115, an institution server 125, an interviewer device 120, a hiring party device 130, and interviewee device 110.

The embodiments support a third-party certified interviewer 160 using the interviewer device 120 to interview an interviewee 165 using the interviewee device 110. The interviewer 160 may have both the required technical qualification to conduct the interview as well as an interview competence. The technical qualification may be knowledge of a technology and/or skill. The interviewing qualifications may be training and/or experience in conducting hiring interviews.

In addition, the embodiments allow an interview coordinator 105 to manage and coordinate the interview between the interviewer 160 and the interviewee 165. The interview coordinator 105 may comprise one or more servers that communicate with the interviewer device 120, the interviewee device 110, a hiring party device 130, and/or a institution server 125 to manage the interview.

In one embodiment, the interview coordinator 105 receives skill data. The skill data may specify a skill that is needed. The skill data may include a technical requirement. In addition, the skill data may identify one or more interviewees 165 for a associated with the skill data.

The interview coordinator 105 may select a case type interview in response to the technical requirement. In one embodiment, the case type interview is received from the institution server 125. The institution server 125 may be maintained by a standard institution such as a software vendor, the hardware vendor, an industry organization, or the like. The standard institution may set standards for the users of its products. For example, a software vendor may establish standards for users of the software vendor's product.

The standard institution may specify one or more case type interviews for assessing the technical competence of candidate users of the standard institution's products. The interview coordinator 105 may receive the case type interview from the institution server 125. In alternate embodiment, the case type interviews are generated at the interview coordinator 105.

The interviewee device 110 may select an interviewer 160. The interviewer 160 may post availability for performing the interview through the interview coordinator 105. In addition, the interview coordinator 105 may communicate the case type interview to the interviewer device 120 of the interviewer 160.

The interviewer 160 may conduct an interview with the interviewee 165 through the interviewer device 120 and the interviewee device 110. In one embodiment, the case type interview is displayed to the interviewer 160 on the interviewer device 120. In addition, model answers corresponding to the case type interview may be displayed to the interviewer 160.

The interviewer 160 may communicate an evaluation based on model answers from the case type interview and the interviewee's responses and/or dialogue during the interview. The interview coordinator 105 may receive the evaluation. In addition, the interview coordinator 105 may provide the evaluation to hiring parties to the hiring party device 130.

The interview coordinator 105, institution server 125, interviewer device 120, interviewee device 110, and hiring party device 130 may communicate over a network 115. The network 115 may be the Internet, a mobile telephone network, a wide-area network, a local area network, a Wi-Fi network, or combinations thereof.

The embodiments are an especially a good fit for a hiring situation at project driven matrix type of organizations, consulting and dispatch nature employers, contractors. The embodiments may also manage a internal transfer situation within a geographically dispersed organization.

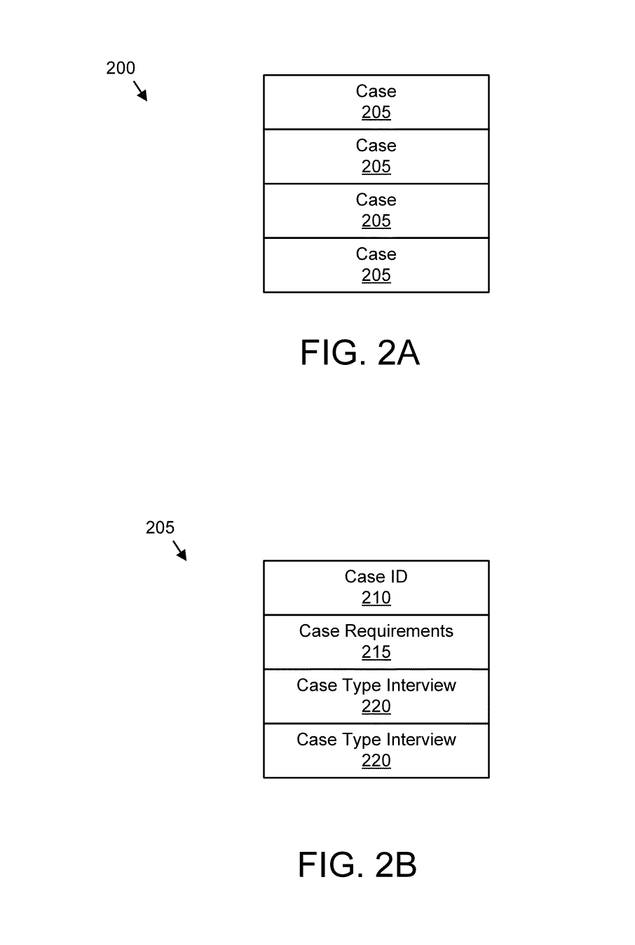

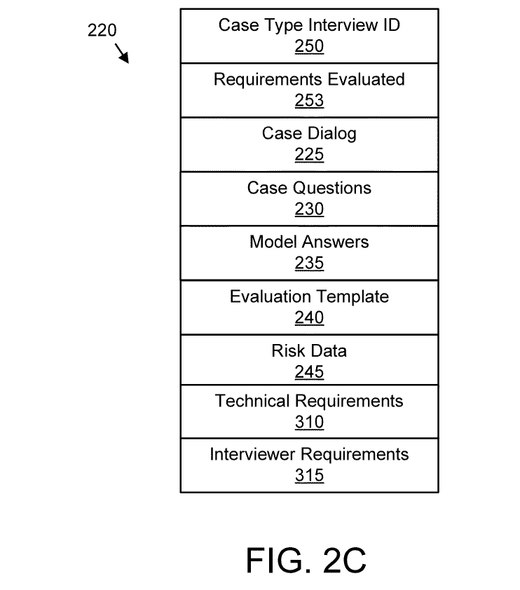

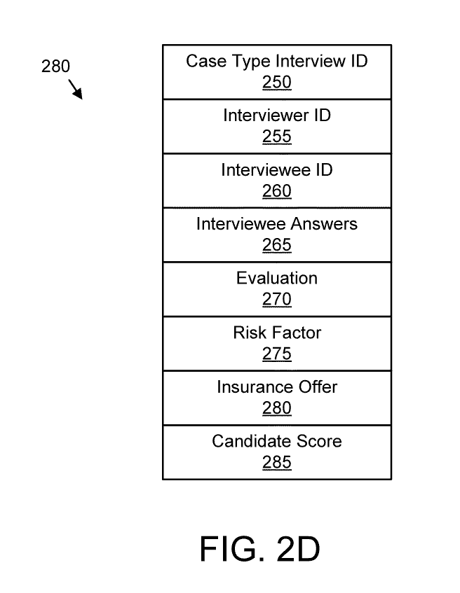

FIG. 2A is a schematic block diagram illustrating one embodiment of a case database 200. The case database 200 maybe organized as a data structure in a memory. The case database 200 includes cases 205. Cases 205 may be generated by the interview coordinator 105. Alternatively, cases 205 may be received from the institution server 125.

FIG. 2B is a schematic block diagram illustrating one embodiment of a case 205. The case 205 maybe organized as a data structure in a memory. In the depicted embodiment, the case 205 includes a case identifier 210, case requirements 215, and one or more case type interviews 220. Each case 205 may include one or more case type interviews 220 for evaluating an interviewee 165.

The case identifier 210 may describe a case type interview type. The case type interview type may be a general category of technical skill. The case requirements 215 may include a detailed description of technical skills covered by case type interviews 220 within the case 205.

FIG. 2C is a schematic block diagram illustrating one embodiment of a case type interview 220. A case type interview 220 may be used by the interviewer 160 when interviewing the interviewee 165. The case type interview 220 maybe organized as a data structure in the memory. In the depicted embodiment, the case type interview 220 includes a case type interview identifier 250, requirements evaluated 253, a case dialogue 225, case questions 230, model answers 235, and evaluation template 240, risk data 245, technical requirements 310, and interview requirements 315.

The case type interview identifier 350 may uniquely identify the case type interview 220. The case type interview identifier 350 may comprise an index value, a title, and the like.

The requirements evaluated 253 may describe skill related requirements that are evaluated by the case type interview 220. The requirements evaluated 253 may specify skills evaluated by the case type interview 250.

The case dialogue 225 may include one or more dialogues that may be modeled when conducting an interview. In one embodiment, the case dialogue 225 is interactive. Branches in the case dialogue 225 may be selected in response to an interviewee's statements and/or answers.

The case questions 230 may comprise questions for eliciting needed information from the interviewee 165. The model answers 235 may include one or more answers to each case question 230. In one embodiment, each model answer 235 includes a skill score that indicates a level of skill.

The evaluation template 240 may organize comments, observations, and/or answers from the interviewee 165. In addition, the evaluation template 240 may score the comments, observations, and/or answers. In one embodiment, the evaluation template 240 is interactive and receives the comments, observations, and answers as entered by the interviewer 160. The evaluation template 240 may calculate a candidate score.

The risk data 245 may be used to calculate a risk factor for a candidate from the candidate score and/or the comments, observations, and answers. The risk data 245 may include an algorithm that calculates the risk factor.

The technical requirements 310 may specify technical knowledge needed by the interviewer 160. The technical requirements 310 may include minimum requirements and optimum requirements.

The interviewer requirements 315 may specify interviewing knowledge needed by the interviewer 160. The interviewer requirements 315 may include minimum requirements and optimum requirements.

FIG. 2D is a schematic block diagram illustrating one embodiment of interview data 280. The interview data 280 may capture the comments, observations, and answers from an interview. The interview data 280 maybe organized as a data structure in the memory. In the depicted embodiment, the interview data 280 includes a case type interview identifier 250, an interviewer identifier 255, an interviewee identifier 260, interviewee answers 265, an evaluation 270, a risk factor 275, an insurance offer 280, and a candidate score 285. The interview data 280 is not accessible by the interviewee 165. The interview data 280 is accessible by the interview coordinator 105 and the interviewer device 120.

The case type interview identifier 250 may uniquely identify the case type interview 220 used during an interview. The interviewer identifier 255 may identify the interviewer 160. The interviewer identifier 255 may include the interviewer's name, contact information, payment information, and the like. The interviewer's identity is withheld from the interviewee 165.

The interviewee identifier 260 may identify the interviewee 165. The interviewee identifier 260 may include the interviewee's name and contact information. Information identifying the interviewee 165 may be withheld from the interviewer 160. In addition, the interviewee identifier 260 may include an address of the interviewee device 110.

The interviewee answers 265 may record the comments, observations, and answers from the interview at the interviewer device 120 and/or the interview coordinator 105. In one embodiment, the interviewee answers 265 are organized in a format specified by the evaluation template 240. The interviewee 165 may be prevented from recording the interviewee answers 265 and/or any information.

The evaluation 270 may estimate the skill level of the interviewee 165. The evaluation 270 may be based on the model answers 235. In one embodiment, a model answer 235 that is representative of an interviewee's response is selected and scored as a skill score. The evaluation 270 may be generated from one or more skill scores.

The risk factor 275 may be calculated from the evaluation 270 using the risk data 245. The risk data 245 may be a probability that the interviewee 165, if hired, will be unable to perform the required tasks for the skill.

The insurance offer 280 may be calculated based on the risk factor 275.

The insurance offer 280 may describe insurance for the hiring party. The insurance offer 280 may include monetary compensation paid to the hiring party if the interviewee 165 is hired and is subsequently unable to perform the required tasks for the skill. The insurance offer 280 may further include a cost to the hiring party for obtaining the insurance.

The candidate score 285 may be calculated from the evaluation 270. The candidate score 285 may be used to rank multiple interviewees 165.

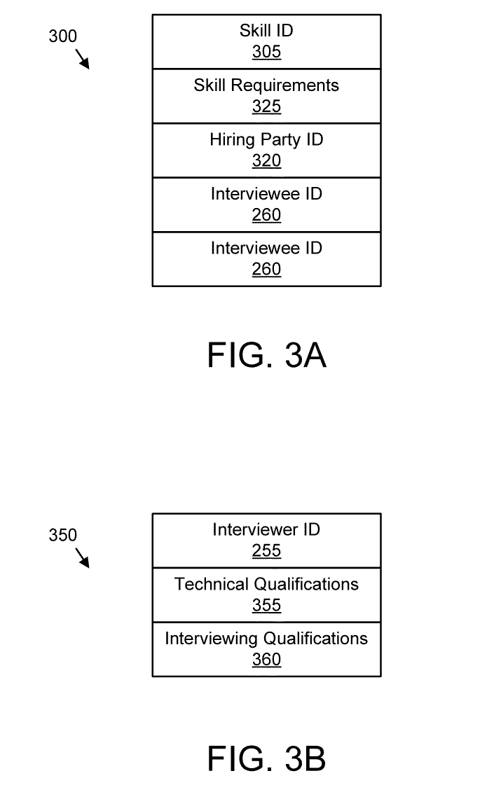

FIG. 3A is a schematic block diagram illustrating one embodiment of a skill data 300. The skill data 300 may describe a skill needed by the hiring party 155. The skill data 300 maybe organized as a data structure in the memory. In the depicted embodiment, the skill data 300 includes a skill identifier 305, skill requirements 325, a hiring party identifier 320, and one or more interviewee identifiers 260.

The skill identifier 305 may uniquely identify the skill that the hiring party seeks to acquire.

The skill requirements 325 may specify the skills needed to perform the tasks of the skill. The skill requirements 325 may be used to identify the case 205 and case type interview 220 used when interviewing the interviewee 165.

The hiring party identifier 320 may identify the hiring party. In one embodiment, the hiring party identifier 320 includes an address of the hiring party device 130.

FIG. 3B is a schematic block diagram illustrating one embodiment of an interviewer data 350. The interviewer data 350 may describe the interviewer 160 and the interviewer's skills. The interviewer data 350 maybe organized as a data structure in a memory. In the depicted embodiment, the interviewer data 350 includes the interviewer identifier 255, technical qualifications 355, and interviewing qualifications 360.

The technical qualifications 355 may describe the technical skills for the interviewer 160. The technical qualifications 355 may be used to determine if the interviewer 160 satisfies the technical requirements 310.

The interviewing qualifications 360 may describe the interviewing skills, experience, education, certifications, and the like for the interviewer 160. The interviewing qualifications 360 may be used to determine if the interviewer 160 satisfies the interviewer requirements 315. The technical qualifications 355 and interviewing qualifications 360 may be established by a separate, credible party.

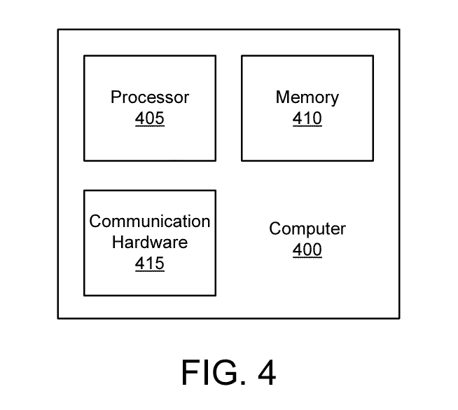

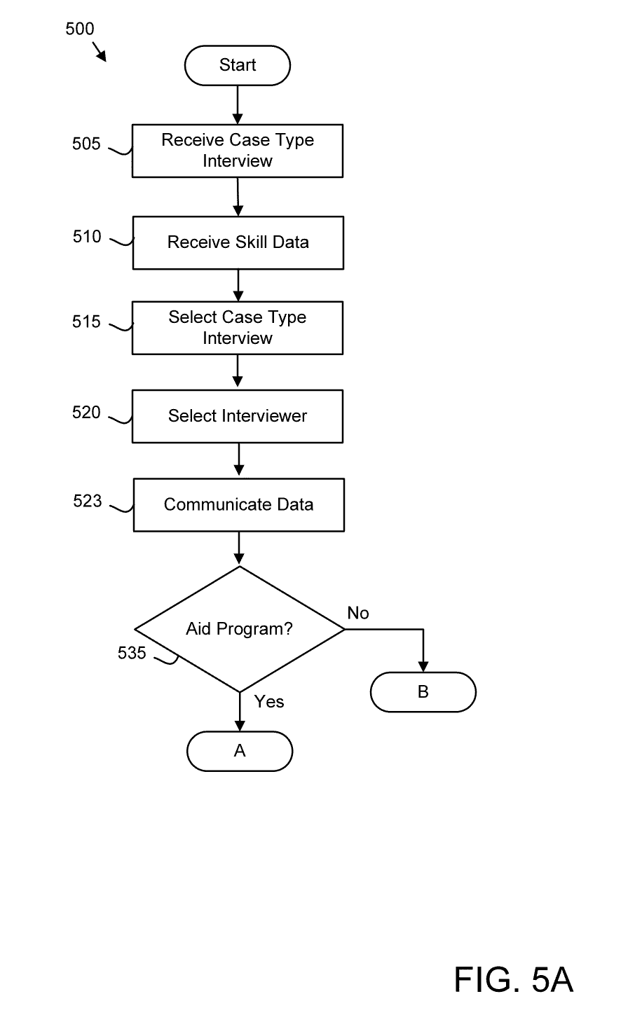

FIG. 4 is a schematic block diagram illustrating one embodiment of a computer 400. The computer 400 may be embodied in one or more of the institution server 125, the interview coordinator 105, the interviewer device 120, the hiring party device 130, and the interviewee device 110, and combinations thereof. In the depicted embodiment, the computer 400 includes a processor 405, a memory 410, and communication hardware 415. The memory 410 may be a semiconductor storage device, a hard disk drive, an optical storage device, a micromechanical storage device, or combinations thereof. The memory 410 may store code. The processor 405 may execute the code. The communication hardware 415 may communicate with other devices and/or the network 115.

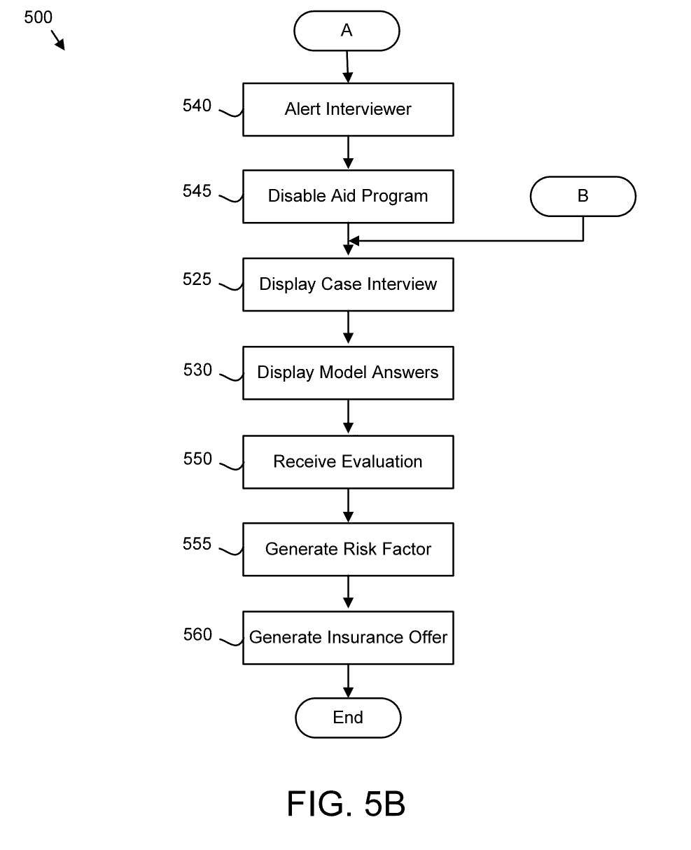

FIGS. 5A-B are schematic flow chart diagrams illustrating one embodiment of a third party interview method 500. The method 500 may facilitate the interviewer 160 interviewing the interviewee 165 for skills specified by the hiring party. The method 500 may be performed by the processor 405. Alternatively, the method 500 may be performed by computer readable storage medium such as the memory 410. The computer readable storage medium may store code that is executed by the processor 405 to perform the functions of the method 500.

The method 500 starts, and in one embodiment, the interview coordinator 105 receives 505 one or more case type interviews 220. The one or more case type interviews 220 may be in a bank of case type interviews 220. The case type interviews 220 may be received from the institution server 125. Alternatively, the case type interviews 220 may be generated by the interview coordinator 105. In one embodiment, the interview coordinator 105 assigns each case type interview 220 to a case 205.

The interview coordinator 105 further receives 510 the skill data 300 for a skill from the hiring party device 130. The skill data 300 includes one or more skill requirements 325 for the skill.

In addition, the interview coordinator 105 selects 510 a case type interview 220 based on the skill requirements 325. In one embodiment, the interview coordinator 105 selects 510 a case 205 based on the skill requirements 325 by matching the skill requirements 325 to the case requirements 215. In addition, the interview coordinator 105 may select 510 the case type interview 220 from the case 205. The case type interview 220 may satisfy the skill requirements 325 if the requirements evaluated 253 for the case type interview 220 are closest match to the skill requirements 325.

The interviewer device 110 may select 520 the interviewer 160. In one embodiment, the interview coordinator 105 creates a qualified interviewer pool of interviewer data 350 with technical qualifications 355 and interviewing qualifications 360 that satisfy the technical requirements 310 and the interviewer requirements 315 respectively. In one embodiment, the interviewer data 350 in the qualified interviewer pool satisfies the minimum technical requirements 310 and minimum interviewer requirements 315. Alternatively, the interviewer data 350 in the qualified interviewer pool may satisfy the optimum technical requirements 310 and the optimum interviewer requirements 315.

The interviewer device 110 may be unaware of the identity of the interviewer 160. In addition, the selected interviewer 160 may not know the interviewee 165.

In one embodiment, the interview coordinator 105 randomly selects 520 the interviewer 160 from the qualified interviewer pool. The selection 520 of the interviewer 160 may be anonymous such that the identity of the interviewer 160 is not communicated to the hiring party device 130. In addition, the interviewer 160 and the interviewee 165 may be mutually anonymous, and the hiring party 155 and the interviewer 160 are anonymous. In addition, the identity of the interviewer 160 may not be communicated to the interviewee device 110.

The interview coordinator 105 may communicate 523 the case type interview 220 and the interview data 280 to the interviewer device 120 of the selected interviewer 160.

In one embodiment, the interview coordinator 105 and/or the interviewer device 120 monitors 535 for an aid program on the interviewee device 110. The aid program may be a communication program allowing the interviewee 165 to receive information from another person. Alternatively, the aid program may be a reference program that retrieves information for later and/or unauthorized use.

In one embodiment, the aid program is a recording program. The aid program may record case type interviews 220, compromising the case database 200. In one embodiment, the interview coordinator 105 installs an application on the interviewee device 110 to monitor for the aid programs. The interviewee 165 may acquiesce to the installation of the application.

If an aid program is not detected, interviewer device 120 may display 525 the case type interview 220 as will be described hereafter. If the aid program is detected, the interview coordinator 105 may alert 540 the interviewer 160 through the interviewer device 120. Alternatively, the interviewer device 120 may alert 540 the interviewer 160.

In one embodiment, the application disables 545 the aid program on the interviewee device 110. The application may disable 545 the aid program as directed by the interview coordinator 105.

The interviewer device 120 may display 525 the case type interview 220. In one embodiment, the interviewer device 120 displays 525 the case type interview 220 as directed by the interview coordinator 105. The interviewer device 120 may further display 530 the model answers 235 for the case type interview 220.

The interview coordinator 105 receives 550 the evaluation 270 from the interviewer device 120. The evaluation 270 may be formatted as specified by the evaluation template 240. In one embodiment, the interview coordinator 105 calculates the candidate score 285 based on the evaluation 270.

In one embodiment, the interview coordinator 105 generates 555 the risk factor 275 from the evaluation 270. In addition, the interview coordinator 105 may generate 560 the insurance offer 280 from the risk factor 275 and the method 500 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
selecting, by use of a processor, a case type interview in response to a skill requirement;
selecting an interviewer in response to the skill requirement;
displaying the case type interview to the interviewer;
displaying model answers corresponding to the case type interview; and
receiving an evaluation based on the model answers.

2. The method of claim 1, the method further comprising:
detecting an aid program; and
alerting the interviewer.

3. The method of claim 1, the method further comprising disabling an aid program.

4. The method of claim 1, wherein the selection of the interviewer is a random selection from a qualified interviewer pool.

5. The method of claim 1, wherein the selection of the interviewer is anonymous, the interviewer and an interviewee are mutually anonymous, and a hiring party and the interviewer are anonymous.

6. The method of claim 1, wherein the interviewer satisfies certification criteria comprising a technical requirement and an interviewer requirement established by a separate creditable party.

7. The method of claim 1, the method further comprising receiving one or more of the case type interview from a standard institution.

8. The method of claim 1, the method further comprising generating a risk factor from the evaluation.

9. The method of claim 6, the method further comprising generating an insurance offer in response to the risk factor.

10. A program product comprising a computer readable storage medium that stores code executable by a processor, the executable code comprising code to perform:
selecting a case type interview in response to a skill requirement;
selecting an interviewer in response to the skill requirement;
displaying the case type interview to the interviewer;
displaying model answers corresponding to the case type interview; and
receiving an evaluation based on the model answers.

11. The program product of claim 10, the code further:
detecting an aid program; and
alerting the interviewer.

12. The program product of claim 10, the code further disabling an aid program.

13. The program product of claim 10, wherein the selection of the interviewer is a random selection from a qualified interviewer pool.

14. The program product of claim 10, wherein the selection of the interviewer is anonymous, the interviewer and an interviewee are mutually anonymous, and a hiring party and the interviewee are anonymous.

15. The program product of claim 10, wherein the interviewer satisfies certification criteria comprising a technical requirement and an interviewer requirement established by a separate creditable party.

16. The program product of claim 10, the code further receiving one or more of the case type interview from a standard institution.

17. The program product of claim 10, the code further generating a risk factor from the evaluation.

18. The program product of claim 17, the code further generating an insurance offer in response to the risk factor.

19. An apparatus comprising:
a processor;
a memory that stores code executable by the processor, the code comprising:
code that selects a case type interview in response to a skill requirement;
code that selects an interviewer in response to the skill requirement;
code that displays the case type interview to the interviewer;
code that displays model answers corresponding to the case type interview; and
code that receives an evaluation based on the model answers.

20. The apparatus of claim 19, wherein the selection of the interviewer is a random selection from a qualified interviewer pool.
